(19) United States
(12) Patent Application Publication
(10) Pub. No.: US 2023/0264410 A1
(43) Pub. Date: Aug. 24, 2023

(54) COMPOSITE PANEL HAVING IMPROVED VIBRATION CHARACTERISTICS AND METHOD FOR MANUFACTURING THE SAME

(71) Applicants: HYUNDAI MOTOR COMPANY, Seoul (KR); KIA CORPORATION, Seoul (KR)

(72) Inventors: Sang Jae Yoon, Yongin-si (KR); Chi Hoon Choi, Suwon-si (KR); Sang Yoon Park, Seoul (KR); Sang Won Lim, Seoul (KR)

(73) Assignees: HYUNDAI MOTOR COMPANY, Seoul (KR); KIA CORPORATION, Seoul (KR)

(21) Appl. No.: 18/076,999

(22) Filed: Dec. 7, 2022

(30) Foreign Application Priority Data
Feb. 21, 2022 (KR) 10-2022-0021898

(51) Int. Cl. B29C 51/14; B32B 3/18; B32B 7/022; B32B 7/028; B32B 7/08; B29C 51/42

(52) U.S. Cl. CPC B29C 51/14; B29C 51/428; B32B 3/18; B32B 7/08; B32B 7/022; B32B 7/028; B29L 2007/002; B32B 2250/05; B32B 2250/40; B32B 2250/42; B32B 2307/56; B32B 2307/736

(57) ABSTRACT

Disclosed are a composite panel having improved vibration characteristics, and a method for manufacturing the same. The composite panel includes a hybrid layer formed at a neutral axis of the composite panel, the hybrid layer including a vibration damping layer and an intermediate material layer. The composite panel also includes structural material layers laminated on both surfaces of the hybrid layer and surface layers laminated on outer surfaces of the respective structural material layers to form outermost layers of the composite panel.

### CROSS-REFERENCE TO RELATED APPLICATION

This application claims the benefit of priority under 35 U.S.C. §119(a) to Korean Patent Application No. 10-2022-0021898, filed in the Korean Intellectual Property Office on Feb. 21, 2022, the entire contents of which are incorporated herein by reference.

### BACKGROUND

### (A) Technical Field

The present disclosure relates to a composite panel having improved vibration characteristics and a method for manufacturing the same. More particularly, the present disclosure relates to a composite panel having a hybrid layer in which a vibration damping layer is concentratedly disposed at a part of a vehicle requiring sound absorption and insulation and a low-cost material is disposed at a part of the vehicle, to which a small external force is applied to achieve cost reduction while improving vibration characteristics. The present disclosure also relates to a method for manufacturing the composite panel.

### (B) Background Art

In general, a panel for vehicles includes an outer panel having a plate shape, an inner panel coupled to one surface of the outer panel, and a reinforcing panel interposed between the outer panel and the inner panel to reinforce rigidity. The respective panels have conventionally been formed of steel to secure rigidity of a vehicle body, but the reinforcing panel is now being formed of carbon fiber reinforced plastic (CFRP) as vehicles have recently been required to be lighter weight.

Particularly, the outer panel, which requires functional aspects, lightweight and implementation of a fine appearance having an emphasized weaving pattern, is generally formed using a composite acquired by laminating continuous carbon fiber sheets. Continuous fibers are used because, in a composite that distributes received external force to different fibers by transmitting the external force to the respective fibers through a matrix and thus has high physical properties, when cut fibers are distributed in the composite, transmitting force is low and thus physical properties are reduced, and the shape of the composite is advantageously maintained when the composite is formed.

Considering load distribution due to the internal structure of a composite panel, when an outer composite plate, having a wide plate shape, is joined, coupled and assembled to a structure part, external force that the panel withstands depending on the behavior of a vehicle is small, and, due to the characteristics of the panel in which respective layers are laminated, force transmitted to a neutral axis is further reduced.

The above information disclosed in this Background section is only for enhancement of understanding of the background of the invention and therefore it may contain information that does not form the prior art that is already known to a person of ordinary skill in the art.

### SUMMARY

Vehicles are exposed to various noise environments, such as the sound of raindrops, wind noise, and road noise, while driving. In an internal combustion engine vehicle, passenger sensitivity to external noise is low because the amount of noise and vibration entering the interior of the vehicle from an engine are considerable. However, in an electric vehicle, passenger sensitivity to external noise is high because there is not an engine in the vehicle. Further, in order to improve the driving efficiency of the electric vehicle, the proportion of lightweight materials, such as plastic, applied to the outer panel of the body of the vehicle is increased. These lightweight materials are vulnerable to Noise, Vibration and Harshness (NVH) due to their characteristics, as compared to steel, for example. Therefore, the area and the disposition structure of a hybrid layer should be set in consideration of purpose of use and production cost.

The present disclosure has been made to solve the above-described problems associated with the prior art, and an objective of the present disclosure is to provide a composite panel having improved vibration characteristics, including a hybrid layer in which disposition of a vibration damping layer is adjusted in consideration of a position requiring sound absorption performance and production costs, and a method for manufacturing the same.

Another objective of the present disclosure is to provide a composite panel having improved vibration characteristics in which a hybrid layer is disposed at the neutral axis of the composite panel and other layers are laminated on the hybrid layer symmetrically around the neutral axis to improve sound absorption and insulation performance, and a method for manufacturing the same.

In one aspect, the present disclosure provides a composite panel having improved vibration characteristics, the composite panel including: a hybrid layer formed at a neutral axis of the composite panel and including a vibration damping layer and an intermediate material layer; respective structural material layers laminated on both upper and lower surfaces of the hybrid layer; and respective surface layers laminated on outer surfaces of the respective structural material layers to form outermost layers of the composite panel.

In an embodiment, a thickness of the hybrid layer may be 11% to 14% of a total thickness of the composite panel.

In another embodiment, the intermediate material layer may include at least one opening, and the vibration damping layer may be located in the at least one opening.

In another embodiment, the at least one opening may be configured such that the vibration damping layer is located therein and may be formed to correspond to a seat arrangement of a vehicle.

In another embodiment, the at least one opening may include a plurality of openings formed radially.

In another embodiment, the damping layer and the intermediate material layer may be configured such that a plurality of vibration damping layer regions and a plurality of intermediate material layer regions are alternately disposed.

In another aspect, the present disclosure provides a method for manufacturing a composite panel having improved vibration characteristics, the method including: laminating a surface layer and a structural material layer on a lower mold and disposing a hybrid layer including a vibration damping layer and an intermediate material layer on an upper surface of the structural material layer; laminating another structural layer and another surface layer on an upper surface of the hybrid layer; preheating the lower mold to a preheating temperature; and molding the composite panel by compressing the laminated layers at a high temperature and a high pressure.

In an embodiment, laminating the surface layer and the structural material layer on the lower mold and disposing the hybrid layer including the vibration damping layer and the intermediate material layer on the upper surface of the structural material layer may include disposing the intermediate material layer and disposing the vibration damping layer between regions of the intermediate material layer to be spaced apart from the regions of the intermediate material layer.

In another embodiment, in disposing the intermediate material layer, the intermediate material layer may be disposed such that an area of the intermediate material layer before molding is 70% to 90% of an area of the intermediate material layer after molding.

In another embodiment, in preheating the lower mold to the preheating temperature, the preheating temperature may be 110° C. to 130° C.

In another embodiment, in molding the composite panel by compressing the laminated layers at the high temperature and the high pressure, the high temperature may be 140° C. to 160° C., and the high pressure may be 90 bar to 110 bar.

Other aspects and embodiments of the disclosure are discussed below.

The above and other features of the disclosure are discussed below.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1 is a cross-sectional view of a composite panel having improved vibration characteristics according to one embodiment of the present disclosure;

FIG. 2 is a perspective top view of one example of a hybrid layer of the composite panel having improved vibration characteristics according to one embodiment of the present disclosure;

FIG. 3 is a top view of another example of the hybrid layer of the composite panel having improved vibration characteristics according to one embodiment of the present disclosure;

FIG. 4 is a top view of yet another example of the hybrid layer of the composite panel having improved vibration characteristics according to one embodiment of the present disclosure;

FIG. 5 is a perspective view illustrating a method for manufacturing the composite panel having improved vibration characteristics according to one embodiment of the present disclosure; and

FIG. 6 is a flowchart representing the method for manufacturing the composite panel having improved vibration characteristics according to one embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, are determined in part by the particular intended application and use environment.

In the figures, reference numbers refer to the same or equivalent parts of the present disclosure throughout the several figures of the drawings.

### DETAILED DESCRIPTION

Hereinafter, references are made in detail to various embodiments of the present disclosure, examples of which are illustrated in the accompanying drawings and described below. The present disclosure is not limited to the embodiments disclosed herein and may be implemented in various forms. The embodiments are provided to make the description of the present disclosure thorough and to fully convey the scope of the present disclosure to those ordinarily skilled in the art.

In the following description of the embodiments, it should be understood that the suffixes “...part” and the like indicate units for processing at least one function or operation and may be implemented using hardware or a combination of hardware and software.

In addition, when an element or layer is referred to as being “on” or “above” another element or layer, it may be directly on the other element or layer, or intervening elements or layers may be present. Further, when an element or layer is referred to as being “under” or “below” another element or layer, the respective element or layer may be directly under the other element or layer, or intervening elements or layers may be present.

It should be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”. Similarly, spatially relative terms, such as “beneath,” “below,” “lower,” “under,” “above,” “upper,” and the like, may be used herein for ease of description to describe one element or feature’s relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Identification marks in respective operations are used for explanation, but do not indicate the sequence of the respective operations, and the respective operations may be executed differently from the sequence specified in the description of the embodiments unless the context clearly indicates the specified sequence.

A composite panel 1000 having improved vibration characteristics according to one embodiment of the present disclosure may be used as a substitute for a carbon fiber reinforced plastic (CFRP) panel. The composite panel 1000 according to the present disclosure may be applied regardless of the assembly form, the application site and the composite panel’s shape. The composite panel 1000 may be applied in the case in which the composite panel 1000 is directly adhered to a vehicle body as a vehicle structure, in the case in which the composite panel 1000 is mechanically assembled with the vehicle body through a separate bracket, in the case in which the composite panel 1000 is used as the upper or lower plate of a vehicle, such as a roof panel or a floor panel, and in the case in which there is a curve for character lines.

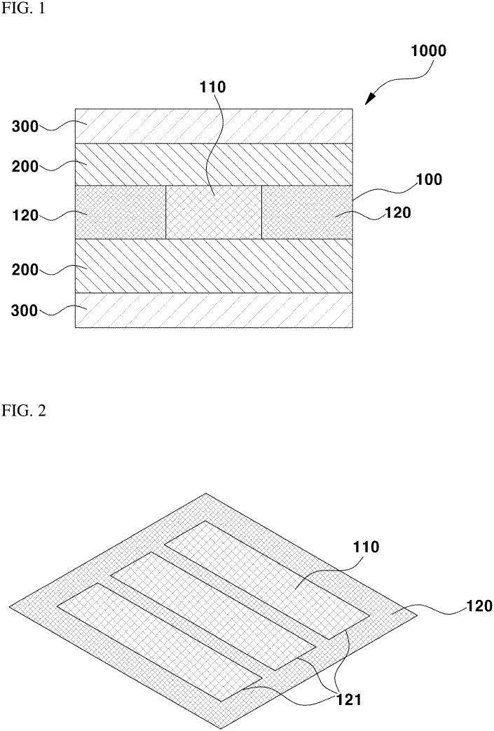

FIG. 1 is a cross-sectional view of a composite panel having improved vibration characteristics according to one embodiment of the present disclosure. FIG. 2 is a perspective top view of one example of a hybrid layer of the composite panel having improved vibration characteristics according to one embodiment of the present disclosure.

Referring to FIGS. 1 and 2, the composite panel 1000 having improved vibration characteristics according to one embodiment of the present disclosure may be formed by laminating a structural material layer 200 and a surface layer 300 on each of the upper (i.e., first) and lower (i.e., second) surfaces of a hybrid layer 100 formed at the neutral axis of the composite panel 1000 so that the structural material layer 200 and the surface layer 300 on the upper surface (i.e., first surface) of the hybrid layer 100 and the structural material layer 200 and the surface layer 300 on the lower surface (i.e., second surface) of the hybrid layer 100 are symmetrical with respect to the hybrid layer 100.

More concretely, the hybrid layer 100 may be formed at the neutral axis of the composite panel 1000, and may include a vibration damping layer 110 and an intermediate material layer 120. The hybrid layer 100 may be formed in a structure in which the intermediate material layer 120 has poor physical properties and low production costs, such that the vibration damping layer 110 is required for sound absorption performance. The intermediate material layer 120 may be configured to support the hybrid layer 100, and the vibration damping layer 110 may be configured such that disposition thereof is changed in response to the positions of passengers.

The thickness of the hybrid layer 100 may be 11% to 14% of the total thickness of the composite panel 1000. In one embodiment, when the total thickness of the composite panel 1000 is 1.6 mm, the thickness of the hybrid layer 100 may be 0.2 mm. As the ratio of the thickness of the hybrid layer 100 increases, production cost is reduced and sound absorption and insulation performance is improved. However, the vibration damping layer 110 may be peeled off or separated due to external force and thus mechanical performance of the hybrid layer 100 may be reduced. Therefore, the thickness of the hybrid layer 100 may not exceed 14% of the total thickness of the composite panel 1000.

In an embodiment, the vibration damping layer 110 may be formed of synthetic rubber. In an embodiment, the vibration damping layer 110 may be formed of ethylene propylene diene monomer (EPDM). In an embodiment, the vibration damping layer 110 may be formed of a material having improved bonding force, acquired by mixing a designated content of the same material as the matrices of the surface layer 300 and the structural material layer 200 with EPDM. The vibration damping layer 110 may be formed of any material which has excellent sound absorption and insulation performance and is not deteriorated under high-temperature and high-pressure compression molding conditions, without being limited to a specific material.

The intermediate material layer 120 may be formed of a material in which fibers and a resin are mixed. The intermediate material layer 120 may be formed of an intermediate material processed by a Sheet Molding Compound (SMC) method. In one embodiment, the intermediate material layer 120 may be a sheet-type intermediate material formed by distributing continuous glass fibers, which are reinforcing materials, cut to a designated length between unsaturated polyester or vinyl ester, which is a thermosetting resin, and then pressing the same.

The fibers in the intermediate material layer 120 may be carbon fibers, glass fibers or aramid fibers. In one embodiment, the content of carbon fibers in the intermediate material layer 120 may be 30 wt% to 60 wt%. The resin in the intermediate material layer 120 may be vinyl ester, unsaturated polyester or epoxy, which is a thermosetting resin. The resin used in the intermediate material layer 120 may be epoxy to minimize differences of material properties with the matrices of the surface layer 300 and the structural material layer 200.

The structural material layers 200 may be laminated on both surfaces of the hybrid layer 100. The surface layers 300 may be laminated on the outer surfaces of the respective structural material layers 200, and may form the outermost layers of the composite panel 1000. The surface layers 300 and the structural material layers 200 may be formed of prepreg including carbon fibers, glass fibers or aramid fibers, and an epoxy-based resin.

A laminate structure used in an outer composite plate may be used as the laminate structure of the surface layers 300 and the structural material layers 200. In an embodiment, a 0°/90° fabric may be used as the respective surface layers 300 to increase productivity, unidirectional continuous fibers oriented at ±45° may be used as the respective structural material layers 200, and the surface layers 300 and the structural material layers 200 may be laminated on both surfaces of the hybrid layer 100 to be symmetrical with respect to the neutral axis of the composite panel 1000. In an embodiment, unidirectional continuous fibers oriented at ±45° may be applied to both the surface layers 300 and the structural material layers 200, and the surface layers 300 and the structural material layers 200 may be laminated on both surfaces of the hybrid layer 100 into inverse structures symmetrical with respect to the neutral axis of the composite panel 1000. In an embodiment, a 0°/90° fabric may be applied to both the surface layers 300 and the structural material layers 200. In an embodiment, a 0°/90° fabric may be used as the respective surface layers 300 and unidirectional continuous fibers may be laminated as the structural material layers 200 using the 0°/90° fabric, so that the surface layers 300 and the structural material layers 200 may be laminated on both surfaces of the hybrid layer 100 to be rotationally symmetrical at angles of 0°/90° with respect to the neutral axis of the composite panel 1000.

The intermediate material layer 120 according to an embodiment of the present disclosure may include at least one opening 121, and may be configured such that the vibration damping layer 110 is located in the opening 121. More concretely, when the application rate of openings 121 is increased, the sound absorption and insulation performance of the composite panel 1000 may be improved, but the mechanical performance of the composite panel 1000 may be reduced and the production cost of the composite panel 1000 may be increased. On the other hand, when the application rate of the openings 121 is decreased, the production cost of the composite panel 1000 may be reduced and the mechanical performance of the composite panel 1000 may be improved, but the sound absorption and insulation performance of the composite panel 1000 may be reduced. Therefore, the application rate of the openings 121 may be determined in consideration of the purpose of use and the production cost of the composite panel 1000.

Further, the openings 121 in which the vibration damping layer 110 is located may be formed to correspond to the seat arrangement of the vehicle. For example, in the case of a 4 or 5-passenger vehicle in which there are first and second rows of seats, two openings 121 may be formed above the first-row seat and the second-row seat, and the vibration damping layer 110 may be disposed within the openings 121. The vibration damping layer 110 may attenuate raindrop sound generated from the roof of the vehicle, wind noise, and road noise generated from the bottom of the vehicle. In the case in which a third-row seat is additionally provided, three openings 121 may be formed, and the vibration damping layer 110 may be disposed within the openings 121, as shown in FIG. 2.

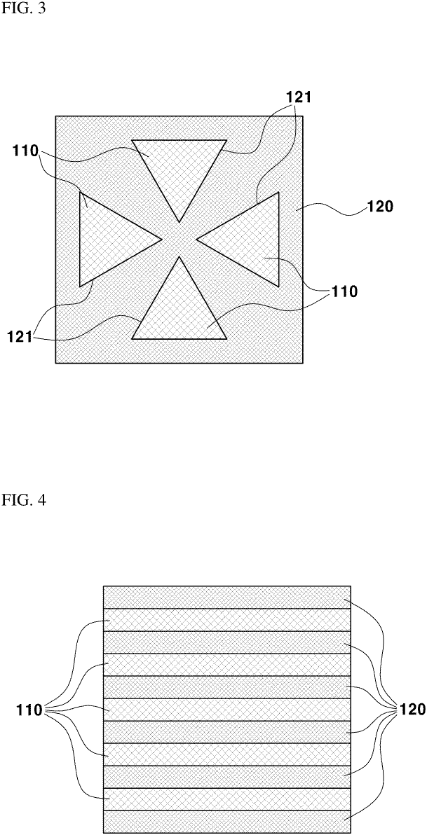

FIG. 3 is a top view of an example of the hybrid layer 100 of the composite panel having improved vibration characteristics according to one embodiment of the present disclosure. FIG. 4 is a top view of yet another example of the hybrid layer 100 of the composite panel having improved vibration characteristics according to one embodiment of the present disclosure.

As an example, referring to FIG. 3, a plurality of openings 121 may be formed radially. As an example, referring to FIG. 4, a damping layer 110 and an intermediate material layer 120 may be formed such that a plurality of vibration damping layer regions and a plurality of intermediate material layer regions are alternately disposed. The positions of the openings 121 may be changed to fit into required performance at positions to which the composite panel 1000 according to the present disclosure is applied. The vibration damping layer 110 located in the openings 121 may be formed to correspond to the required degree of sound absorption and insulation performance.

In another embodiment of the present disclosure, the hybrid layer 100 may be disposed at any other position than the neutral axis in the thickness direction of the composite panel 1000. For example, in the case in which the required degree of sound absorption and insulation performance is reduced, or in the case in which the thickness of the composite panel 1000 needs to be increased, a plurality of hybrid layers 100 may be laminated in the thickness direction of the composite panel 1000.

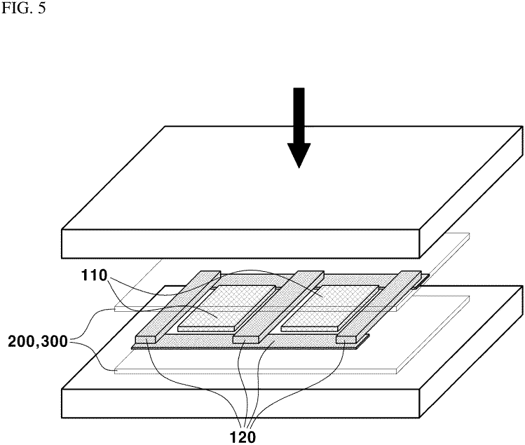

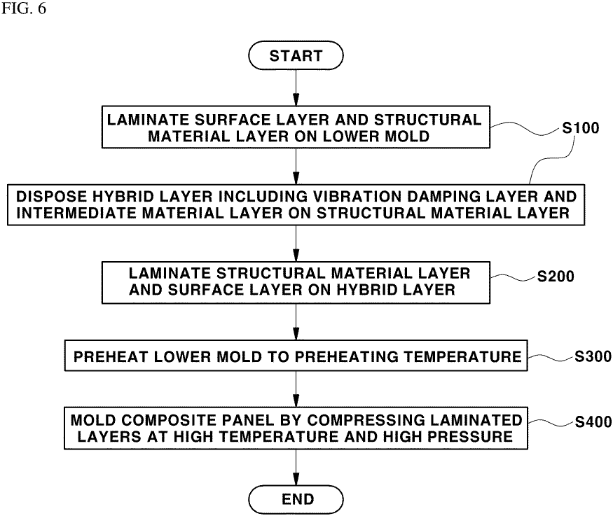

FIG. 5 is a perspective view illustrating a method for manufacturing the composite panel having improved vibration characteristics according to one embodiment of the present disclosure. FIG. 6 is a flowchart representing the method for manufacturing the composite panel having improved vibration characteristics according to an embodiment of the present disclosure.

Referring to FIGS. 5 and 6, the method for manufacturing the composite panel having improved vibration characteristics according to an embodiment of the present disclosure may include laminating one surface layer 300 and one structural material layer 300 on a lower mold and disposing the hybrid layer 100 including the vibration damping layer 110 and the intermediate material layer 120 on the upper surface of the structural material layer 200 (S100), laminating another structural layer 200 and another surface layer 300 on the upper surface of the hybrid layer 100 (S200), preheating the lower mold to a preheating temperature (S300), and molding the composite panel 1000 by compressing the laminated layers at a high temperature and a high pressure (S400).

More concretely, the operation of laminating the surface layer 300 and the structural material layer 300 on the lower mold and disposing the hybrid layer 100 including the vibration damping layer 110 and the intermediate material layer 120 on the upper surface of the structural material layer 200 (S100) may include disposing the intermediate material layer 120 (S110), and disposing the vibration damping layer 110 between regions of the intermediate material layer 120 to be spaced apart from the regions of the intermediate material layer 120 (S120).

In the operation of laminating the surface layer 300 and the structural material layer 300 on the lower mold and disposing the hybrid layer 100 including the vibration damping layer 110 and the intermediate material layer 120 on the upper surface of the structural material layer 200 (S100), the surface layer 300 and the structural material layer 200 may be evenly laminated on the upper surface of the lower mold and, thereafter, the hybrid layer 100 may be evenly disposed on the upper surface of the structural material layer 200.

In the operation of disposing the intermediate material layer 120 (S110), the intermediate material layer 120 may be disposed such that the area of the intermediate material layer 120 before molding is 70% to 90% of the area of the intermediate material layer 120 after molding. The area of the intermediate material layer 120 after molding may correspond to the area of the surface layer 300 and the structural material layer 200. Further, the intermediate material layer 120 may be disposed such that contacts points between the respective regions of the intermediate layer 120 are provided to prevent formation of weld lines where fibers meet during the molding process. In the operation of disposing the vibration damping layer 110 between the regions of the intermediate material layer 120 to be spaced apart from the regions of the intermediate material layer 120 (S120), the vibration damping layer 110 may be disposed in spaces formed by disposition of the intermediate material layer 120.

In the operation of laminating the structural material layer 200 and the surface layer 300 on the upper surface of the hybrid layer 100, the structural material layer 200 and the surface layer 300 may be sequentially laminated on the intermediate layer 120 and the vibration damping layer 110. The method for manufacturing the composite panel 1000 having improved vibration characteristics according to one embodiment of the present disclosure may further include preheating the lower mold to the preheating temperature (S300), before molding the composite panel 1000 by compressing the laminated layers (S400). In the operation of preheating the lower mold to the preheating temperature (S300), the preheating temperature, may be 110° C. to 130° C. In one example, the preheating temperature may be 120° C.

In the operation of molding the composite panel 1000 by compressing the laminated layers at the high temperature and the high pressure (S400), an upper mold may be located on the surface layer 300, and the upper mold and the lower mold may be pressed, thus being capable of compressing the laminated layers. In the operation of molding the composite panel 1000 by compressing the laminated layers at the high temperature and the high pressure (S400), the high temperature, i.e., the molding temperature, may be 140° C. to 160° C., and the high pressure, i.e., the molding pressure, may be 90 bar to 110 bar. In one example, the molding temperature may be 150° C., and the molding pressure may be 100 bar.

In summary, the present disclosure provides a composite panel having improved vibration characteristics, including a hybrid layer in which disposition of a vibration damping layer is adjusted in consideration of positions requiring sound absorption performance and production cost, and the method for manufacturing the same.

As should be apparent from the above description, the present disclosure provides the following effects through the configuration and connection and usage relations described above in the embodiments.

A composite panel having improved vibration characteristics according to the present disclosure includes a hybrid layer in which disposition of a vibration damping layer is adjusted in consideration of positions requiring sound absorption performance where passengers are to be seated, thereby improving efficiency in sound absorption and insulation performance and reducing production cost.

Further, the hybrid layer is disposed at the neutral axis of the composite panel and other layers are laminated on the hybrid layer symmetrically around the neutral axis, thereby being capable of improving the sound absorption and insulation performance.

The disclosure has been described in detail with reference to embodiments thereof. However, it should be appreciated by those ordinarily skilled in the art that changes may be made in these embodiments without departing from the principles and spirit of the disclosure, the scope of which is defined in the appended claims and their equivalents. While the disclosure has been explained in relation to embodiments thereof, it should be understood that various modifications are apparent upon reading the specification to those ordinarily skilled in the art. These embodiments have been described to explain the best mode to implement the technical scope of the disclosure, and various modifications required in the specific application and purpose of the present disclosure are possible. Therefore, the above detailed description of the present disclosure is not intended to limit the disclosure. Further, it must be interpreted that the accompanying claims encompass other modes.

What is claimed is:

1. A composite panel having improved vibration characteristics, the composite panel comprising:
a hybrid layer formed at a neutral axis of the composite panel, and comprising a vibration damping layer and an intermediate material layer;
respective structural material layers laminated on both upper and lower surfaces of the hybrid layer; and
respective surface layers laminated on outer surfaces of the respective structural material layers to form outermost layers of the composite panel.

2. The composite panel having improved vibration characteristics of claim 1, wherein a thickness of the hybrid layer is 11% to 14% of a total thickness of the composite panel.

3. The composite panel having improved vibration characteristics of claim 1, wherein:
the intermediate material layer comprises at least one opening; and
the vibration damping layer is located in the at least one opening.

4. The composite panel having improved vibration characteristics of claim 3, wherein the at least one opening is configured such that the vibration damping layer is located therein and is formed to correspond to a seat arrangement of a vehicle.

5. The composite panel having improved vibration characteristics of claim 3, wherein the at least one opening comprises a plurality of openings formed radially.

6. The composite panel having improved vibration characteristics of claim 1, wherein the damping layer and the intermediate material layer are configured such that a plurality of vibration damping layer regions and a plurality of intermediate material layer regions are alternately disposed.

7. A method for manufacturing a composite panel having improved vibration characteristics, the method comprising:
laminating a surface layer and a structural material layer on a lower mold, and disposing a hybrid layer comprising a vibration damping layer and an intermediate material layer on an upper surface of the structural material layer;
laminating another structural layer and another surface layer on an upper surface of the hybrid layer;
preheating the lower mold to a preheating temperature; and
molding the composite panel by compressing the laminated layers at a high temperature and a high pressure.

8. The method of claim 7, wherein laminating the surface layer and the structural material layer on the lower mold and disposing the hybrid layer comprising the vibration damping layer and the intermediate material layer on the upper surface of the structural material layer comprise:
disposing the intermediate material layer; and
disposing the vibration damping layer between regions of the intermediate material layer to be spaced apart from the regions of the intermediate material layer.

9. The method of claim 8, wherein, in disposing the intermediate material layer, the intermediate material layer is disposed such that an area of the intermediate material layer before molding is 70% to 90% of an area of the intermediate material layer after molding.

10. The method of claim 7, wherein, in preheating the lower mold to the preheating temperature, the preheating temperature is 110° C. to 130° C.

11. The method of claim 7, wherein, in molding the composite panel by compressing the laminated layers at the high temperature and the high pressure, the high temperature is 140° C. to 160° C., and the high pressure is 90 bar to 110 bar.
